(19) United States
(12) Patent Application Publication
(10) Pub. No.: US 2015/0085172 A1
(43) Pub. Date: Mar. 26, 2015

(54) IMAGE CAPTURING APPARATUS AND CONTROL METHOD THEREOF

(71) Applicant: CANON KABUSHIKI KAISHA, Tokyo (JP)

(72) Inventor: Masaaki Uenishi, Kawasaki-shi (JP)

(21) Appl. No.: 14/494,374

(22) Filed: Sep. 23, 2014

(30) Foreign Application Priority Data
Sep. 25, 2013 (JP) 2013-198897

(51) Int. Cl. H04N 5/232; H04N 5/378

(52) U.S. Cl. CPC H04N 5/23212; H04N 5/23293; H04N 5/378
USPC 348/333.11; 348/349

(57) ABSTRACT

An image capturing apparatus comprising: an image sensor; a setting unit configured to set, in the image sensor, a first region for obtaining a focus detection signal, and a second region, larger than the first region and contains the first region, for obtaining an image signal; a focus control unit configured to carry out focus control by finding an in-focus position of a focus lens using the focus detection signal output from the first region; and a readout unit configured to read out the focus detection signal from the first region and the image signal from the second region in parallel. The readout unit sets a framerate for reading out the focus detection signal to be higher than a framerate for reading out the image signal.

### BACKGROUND OF THE INVENTION

1. Field of the Invention

The present invention relates to image capturing apparatuses and control methods thereof, and particularly relates to image capturing apparatuses that automatically carry out focus control, and to control methods thereof.

2. Description of the Related Art

Conventionally, an autofocus (AF) technique that automatically carries out focus control using an image signal obtained from an image sensor such as a CCD or a CMOS sensor has been employed in digital still cameras and the like as a method for moving a focus lens position and focusing on an object. With such an AF technique, generating a focus evaluation value using signals obtained from all of the pixels in the image sensor results in readout taking a long time. In response to this, there is a technique that shortens readout times and speeds up AF by using an image signal obtained by adding a predetermined number of pixels at a predetermined pixel interval thereby decimating image signals in a predetermined direction in an image region (called a “decimated added signal” hereinafter). However, adding and decimating image signals affects the frequency characteristics of an object, and thus as shown in FIG. 10, a peak position of the focus evaluation value calculated using the signals from all of the pixels will differ from a peak position of the focus evaluation value calculated using the decimated added signal. As a result, in the case where the image to be captured uses signals from all of the pixels, the image to be captured cannot be brought into focus when AF is carried out using the focus evaluation value calculated using the decimated added signal. Thus a method in which the readout time is shortened by reading out only a partial region of an image region, rather than adding or decimating the image, can be considered as another method. This technique, however, reads out only a partial region, and as such the resulting image cannot be used in a live view display.

There is another technique in which two image sensors are provided, image data from the two image sensors is output in an alternating manner, and one instance of image data is used to control the capturing of a moving picture while the other instance of image data is used for AF control; high-speed driving is achieved in the AF control by employing exposure control, pixel adding, and the like suited to AF (see Japanese Patent Laid-Open No. 2007-097033).

However, the technique disclosed in Japanese Patent Laid-Open No. 2007-097033 requires two image sensors, which increases both the size of the device and the cost thereof. Furthermore, a technique that outputs image data in an alternating manner takes time due to long readout times for the signals from all of the pixels. Further still, the two instances of image data cannot be used simultaneously in the technique that outputs the image data in an alternating manner.

### SUMMARY OF THE INVENTION

The present invention has been made in consideration of the above situation, and makes it possible to carry out AF quickly while maintaining the accuracy of the AF.

According to the present invention, provided is an image capturing apparatus comprising: an image sensor; a setting unit configured to set, in the image sensor, a first region for obtaining a focus detection signal, and a second region, for obtaining an image signal, that is larger than the first region and contains the first region; a focus control unit configured to carry out focus control by finding an in-focus position of a focus lens using the focus detection signal output from the first region; and a readout unit configured to read out the focus detection signal accumulated in the image sensor from the first region and reads out the image signal accumulated in the image sensor from the second region, wherein the readout unit reads out the focus detection signal in parallel with the image signal, and sets a framerate of the focus detection signal read out from the first region to be higher than a framerate of the image signal read out from the second region.

Further, according to the present invention, provided is an image capturing apparatus comprising: an image sensor; a setting unit configured to set, in the image sensor, a first region for obtaining a focus detection signal, and a second region, for obtaining an image signal, that is larger than the first region and contains the first region; a focus control unit configured to carry out focus control by finding an in-focus position of a focus lens using the focus detection signal output from the first region; a readout unit configured to read out the focus detection signal accumulated in the image sensor from the first region and reads out the image signal accumulated in the image sensor from the second region; and a display unit configured to display the image signal obtained from the second region, wherein the readout unit obtains the image signal from the second region having carried out at least one of adding and decimation on the image signal; and wherein the readout unit reads out the focus detection signal in parallel with the image signal, and sets a framerate of the focus detection signal read out from the first region to be higher than a framerate of the image signal read out from the second region.

Furthermore, according to the present invention, provided is a control method for an image capturing apparatus, the method comprising: a setting step of setting, in an image sensor of the image capturing apparatus, a first region for obtaining a focus detection signal, and a second region, for obtaining an image signal, that is larger than the first region and contains the first region; a readout step of reading out the focus detection signal accumulated in the image sensor from the first region and reading out the image signal accumulated in the image sensor from the second region; and a focus control step of carrying out focus control by finding an in-focus position of a focus lens using the focus detection signal output from the first region, wherein in the readout step, the focus detection signal is read out in parallel with the image signal, and a framerate of the focus detection signal read out from the first region is set to be higher than a framerate of the image signal read out from the second region.

Further, according to the present invention, provided is a control method for an image capturing apparatus, the method comprising: a setting step of setting, in an image sensor of the image capturing apparatus, a first region for obtaining a focus detection signal, and a second region, for obtaining an image signal, that is larger than the first region and contains the first region; a readout step of reading out the focus detection signal accumulated in the image sensor from the first region and reading out the image signal accumulated in the image sensor from the second region; a focus control step of carrying out focus control by finding an in-focus position of a focus lens using the focus detection signal output from the first region; and a display step of displaying the image signal obtained from the second region, wherein in the readout step, the image signal is obtained from the second region having carried out at least one of adding and decimation on the image signal; and in the readout step, the focus detection signal is read out in parallel with the image signal, and a framerate of the focus detection signal read out from the first region is set to be higher than a framerate of the image signal read out from the second region.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram illustrating a configuration of an image capturing apparatus according to an embodiment of the present invention;

FIG. 2 is a diagram illustrating a configuration of pixels provided in the image capturing apparatus according to an embodiment;

FIG. 3 is a timing chart illustrating signals output from a vertical scanning circuit when obtaining an image;

FIG. 4 is a diagram illustrating charge accumulation periods and image readout timings;

FIG. 5 is a flowchart illustrating the overall flow of an image capturing process according to an embodiment;

FIG. 6 is a flowchart illustrating AF operations according to an embodiment;

FIG. 7 is a flowchart illustrating a process for setting a focus detection region according to an embodiment;

FIG. 8 is a flowchart illustrating determination of a readout method, indicated in FIG. 6, according to an embodiment;

FIGS. 9A to 9C are diagrams illustrating readout regions for a plurality of readout methods; and

FIG. 10 is a diagram illustrating a peak position of a focus evaluation value calculated using signals from all pixels and a peak position of a focus evaluation value calculated using a decimated added signal.

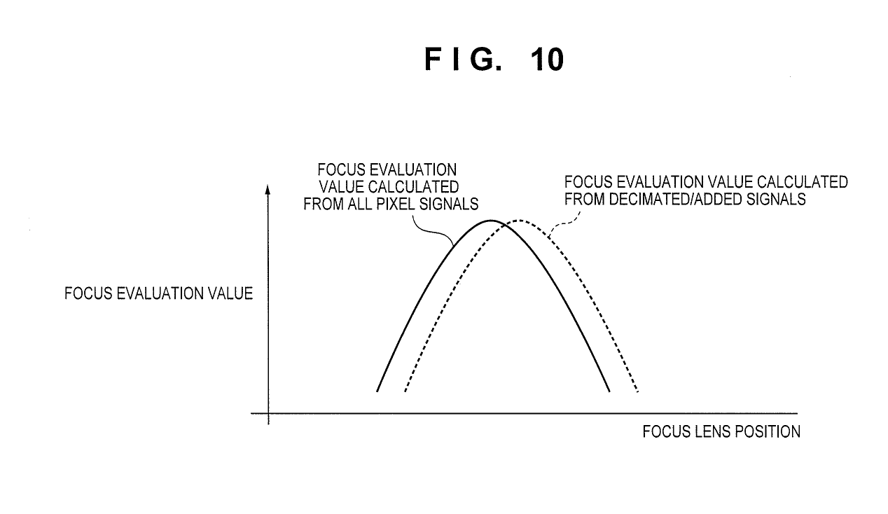

### DESCRIPTION OF THE EMBODIMENTS

Exemplary embodiments of the present invention will be described in detail in accordance with the accompanying drawings.

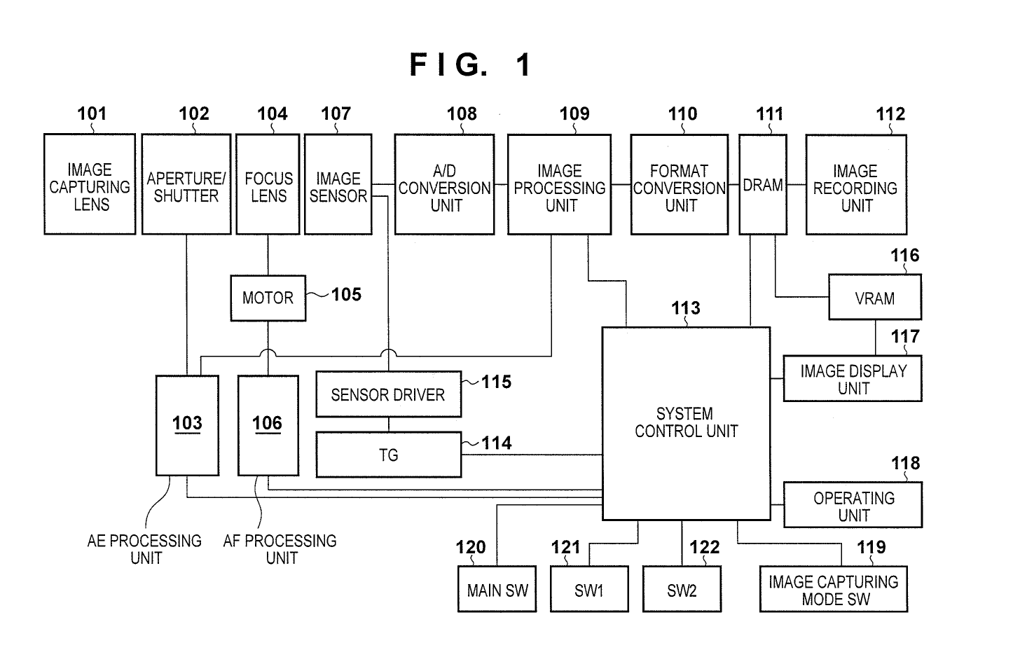

FIG. 1 is a block diagram illustrating the configuration of a digital camera serving as an image capturing apparatus according to an embodiment of the present invention. As shown in FIG. 1, light that is reflected from an object and that enters via an image capturing lens 101 that includes a zoom mechanism and an aperture/shutter 102 that controls a light amount is formed on an image sensor 107 by a focus lens 104. The image sensor 107 receives the light that has been formed, converts the light into an electrical signal, and outputs the signal to an A/D conversion unit 108. The A/D conversion unit 108 includes a CDS circuit that reduces output noise from the electrical signal output from the image sensor 107, a non-linear amplifier used prior to the A/D conversion, an A/D conversion circuit that carries out the A/D conversion, and the like, and outputs a digital image signal resulting from the conversion to an image processing unit 109.

The image processing unit 109 carries out predetermined image processes such as gamma conversion on the image signal output from the A/D conversion unit 108, after which the image signal is converted into a format suited to recording, display, or the like by a format conversion unit 110 and then stored in an internal memory 111. The internal memory 111 is a high-speed memory such as a random access memory, and will be referred to hereinafter as a “DRAM”. The DRAM 111 is used as a high-speed buffer for temporarily storing images or as a working memory for compressing and decompressing images. An image recording unit 112 is configured of a recording medium such as a memory card and an interface thereof, and records images and the like via the DRAM 111. In addition to displaying images, an image display unit 117 performs displays for operational assistance, displays camera statuses, and when capturing images, displays an image capturing screen and a focus detection region; the displays are carried out via an image display memory 116 (referred to as a “VRAM” hereinafter).

An operating unit 118 is a unit for operating the camera from the exterior, and includes switches such as those described hereinafter. That is, there is a menu switch for making various types of settings such as setting image capturing functions and image playback in the image capturing apparatus, detailed settings for various image capturing modes, and so on, a zoom lever for instructing the image capturing lens 101 to perform zoom operations, an operating mode toggle switch for toggling between an image capturing mode and a playback mode, and so on. Furthermore, an image capturing mode switch 119 is a switch for selecting an image capturing mode such as a macro mode, a distant scene mode, or the like, and in the present embodiment, the focus detection region, a range across which the focus lens 104 is driven, AF operations, and so on are altered depending on the image capturing mode selected by a user. The camera further includes a main switch 120 for powering on the camera system, a switch 121 for performing image capturing preparation operations such as AF, AE, and the like (referred to as “SW1” hereinafter), and an image capturing switch 122 for capturing an image after SW1 has been manipulated (referred to as “SW2” hereinafter).

Meanwhile, a system control unit 113 controls the system as a whole, including an image capturing sequence. An AE processing unit 103 carries out photometry processing on the processed image signal output from the image processing unit 109, finds an AE evaluation value for exposure control, and controls the exposure by controlling the shutter speed, aperture, and sensitivity. Note that in the case where the image sensor 107 has an electronic shutter function, the AE processing unit 103 also controls the reset and readout timing of the image sensor 107. An AF processing unit 106 moves the focus lens 104 by driving a motor 105 in accordance with focus adjustment control (AF processing), which will be described later.

A predetermined timing signal is output to system control unit 113 and a sensor driver 115 from a timing generator (TG) 114, and the system control unit 113 carries out various types of control in synchronization with this timing signal. The sensor driver 115 receives the timing signal from the TG 114 and drives the image sensor 107 in synchronization therewith.

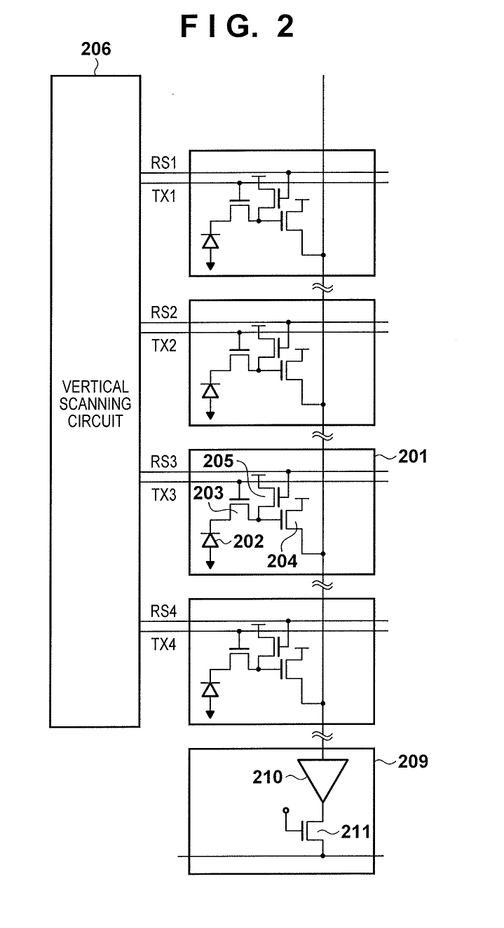

Next, the configuration of pixels provided in the image sensor 107 shown in FIG. 1 will be described with reference to FIG. 2. Note that although FIG. 2 indicates four pixels arranged in the vertical direction, in actuality, the image sensor 107 includes an extremely large number of pixels arranged two-dimensionally.

Reference numeral 201 indicates a pixel that receives light that has passed through an imaging lens system including the image capturing lens 101, the aperture/shutter 102, and the focus lens 104; the pixel 201 photoelectrically converts the light that has entered the surface and outputs an electrical signal. The pixel 201 includes a photodiode 202, a transfer transistor 203, an amplifier 204, and a reset transistor 205. The transfer transistor 203 and the reset transistor 205 operate in response to a signal from a vertical scanning circuit 206. The vertical scanning circuit 206 includes a shift register, a signal generating circuit that generates driving signals for the transfer transistor 203 and so on to drive the respective pixels, and the like. By controlling the transfer transistor 203 and the reset transistor 205 using the generated driving signals (TX1 to 4, RS1 to 4, and so on), a charge in the photodiode 202 can be reset and read out, thus a charge accumulation period can be controlled.

Meanwhile, a horizontal scanning circuit 209 includes a shift register, a column amp circuit 210, a signal output selection switch 211, an output circuit (not shown) for output to the exterior, and so on. The signals read out from the pixel can be amplified by changing settings of the column amp circuit 210 through a signal from the sensor driver 115.

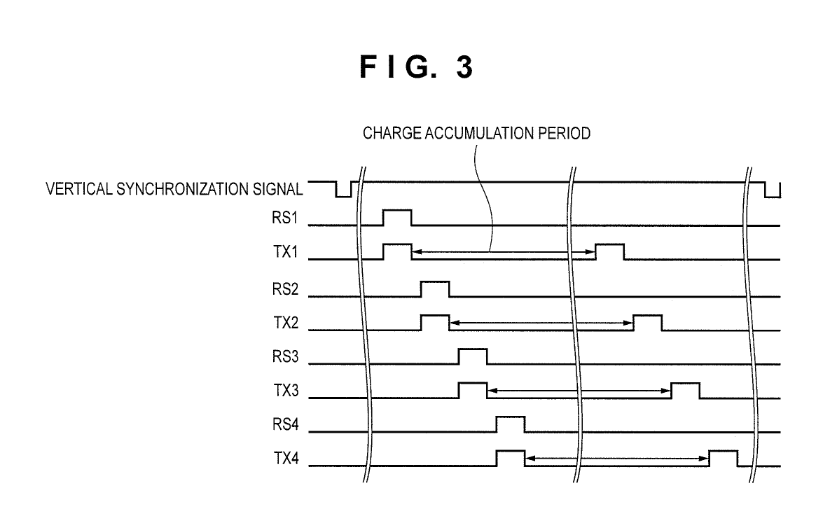

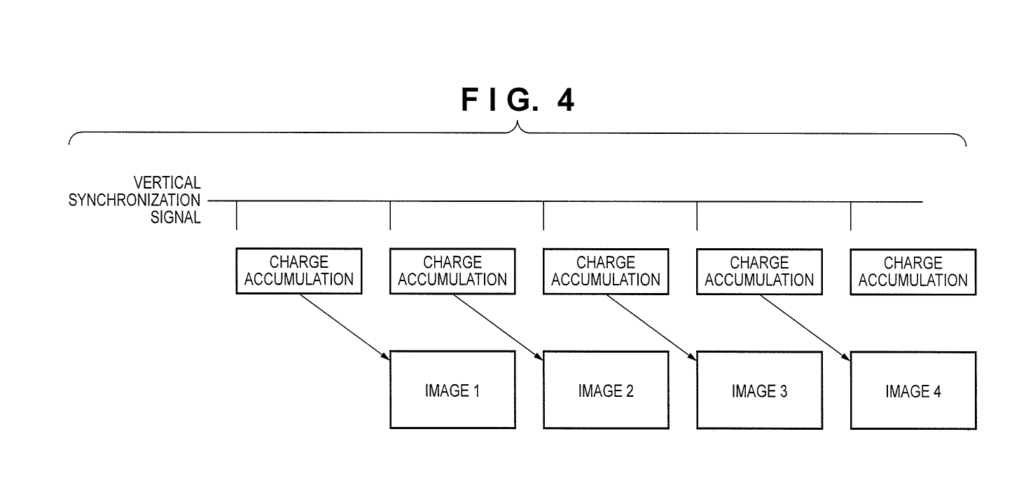

Next, typical control of the image sensor 107 having pixels configured as shown in FIG. 2, performed when obtaining an image, will be described with reference to FIGS. 3 and 4. FIG. 3 is a timing chart illustrating signals generated by the vertical scanning circuit 206 when obtaining an image.

When both a TX signal (TX1 to 4) and an RS signal (RS1 to 4) in each row become high, the charge in the photodiode 202 of each pixel is reset, whereas charge accumulation starts when both the TX signal and the RS signal become low. This operation is carried out sequentially according to a predetermined order under conditions set by the TG 114. Then, after a predetermined charge accumulation period has passed, the TX signal becomes high again, and the charge in the photodiode 202 is read out to a gate of the amplifier 204. An image signal is generated from the signal from the amplifier 204 and is output through the horizontal scanning circuit 209. This operation is also carried out under conditions set by the TG 114.

In the present embodiment, the image sensor 107 provided in the image capturing apparatus 1 is a CMOS image sensor. Accordingly, depending on the settings of the shift register in the vertical scanning circuit 206, it is possible to select in what order to drive the transfer transistors 203 of a given row; furthermore, the same row can be selected repeatedly and the signals read out therefrom. Furthermore, depending on the settings of the shift register in the horizontal scanning circuit 209, it is possible to select which column signal will be output from among signals in the same row, by causing the selection switch 211 of that column to operate. Through this, it is possible to specify from which pixels and in which order signals are to be read out.

FIG. 4 illustrates charge accumulation periods and the timings at which accumulated charges are read out as images. Exposure and signal readout are carried out based on vertical synchronization signals generated by the TG 114 and the sensor driver 115.

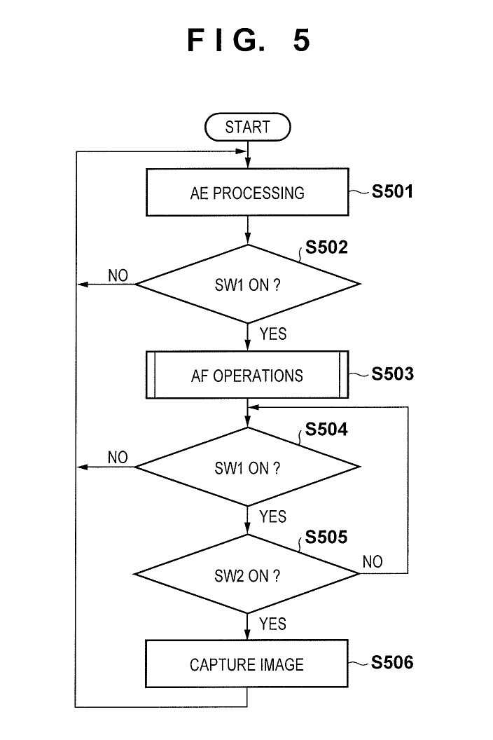

Next, operations performed according to this embodiment of the present invention will be described in detail using FIGS. 5 to 9C. FIG. 5 is a flowchart illustrating the overall flow of an image capturing process. First, in step S501, the AE processing unit 103 carries out AE processing based on the output of the image processing unit 109, and the process then moves to step S502. The state of SW1 is examined in step S502; the process moves to step S503 when SW1 is on, and returns to step S501 when SW1 is not on. In step S503, AF operations, which will be described later, are carried out, after which the process moves to step S504. The state of SW1 is examined in step S504; the process moves to step S505 when SW1 is on, and returns to step S501 when SW1 is not on. The state of SW2 is examined in step S505; the process moves to step S506 when SW2 is on, and returns to step S504 when SW2 is not on. In step S506, image capturing operations are carried out, after which the process returns to step S501.

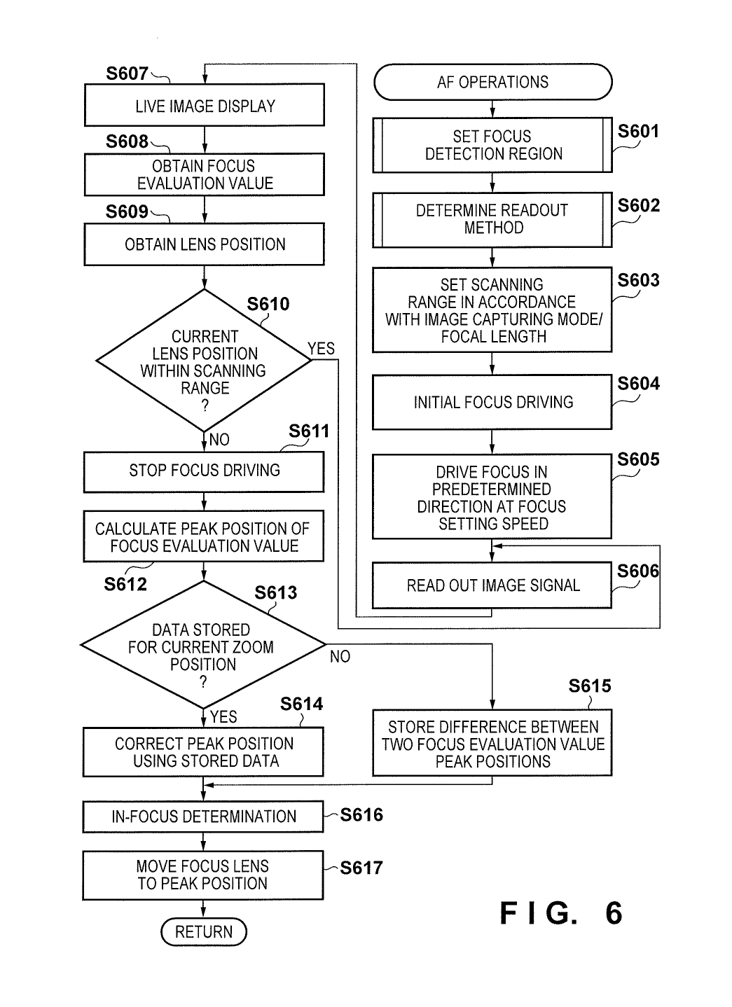

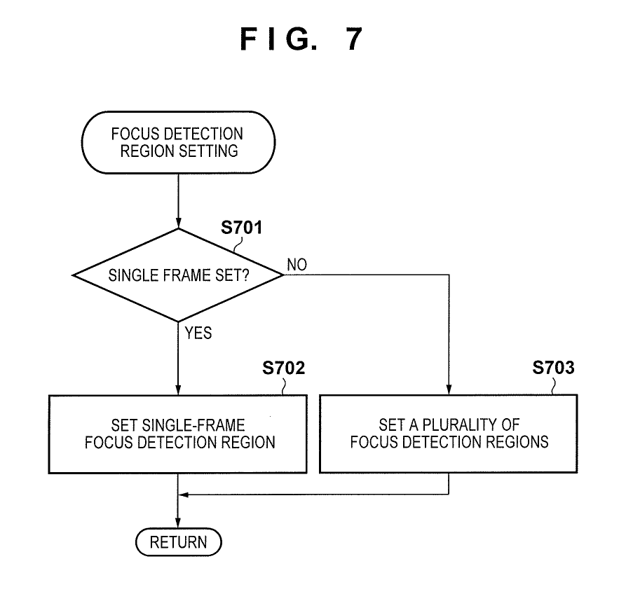

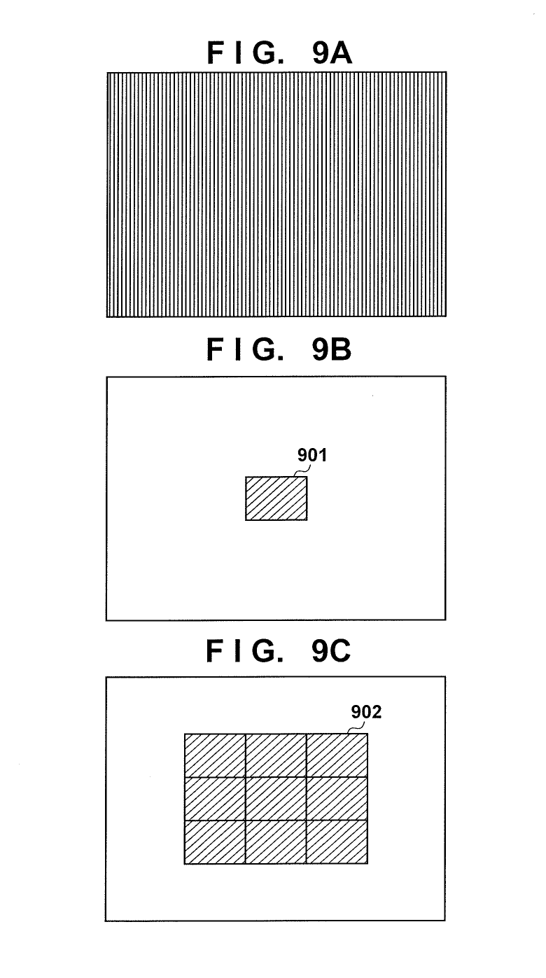

FIG. 6 is a flowchart illustrating the AF operations carried out in step S503 of FIG. 5. First, in step S601, the focus detection region is set. Here, the process for setting the focus detection region carried out in step S601 will be described with reference to the flowchart in FIG. 7. In step S701, it is determined whether or not the setting of the focus detection region is a single-frame setting, and in the case where the setting is a single-frame setting, the process moves to step S702, whereas in the case where the setting is not a single-frame setting, the process moves to step S703. In step S702, a single-frame focus detection region 901 is set in a predetermined region as shown in FIG. 9B, after which the flow ends and the process moves to step S602. In step S703, a plurality of focus detection regions 902 are set in a predetermined region, as shown in FIG. 9C, after which the process moves to step S602 in FIG. 6.

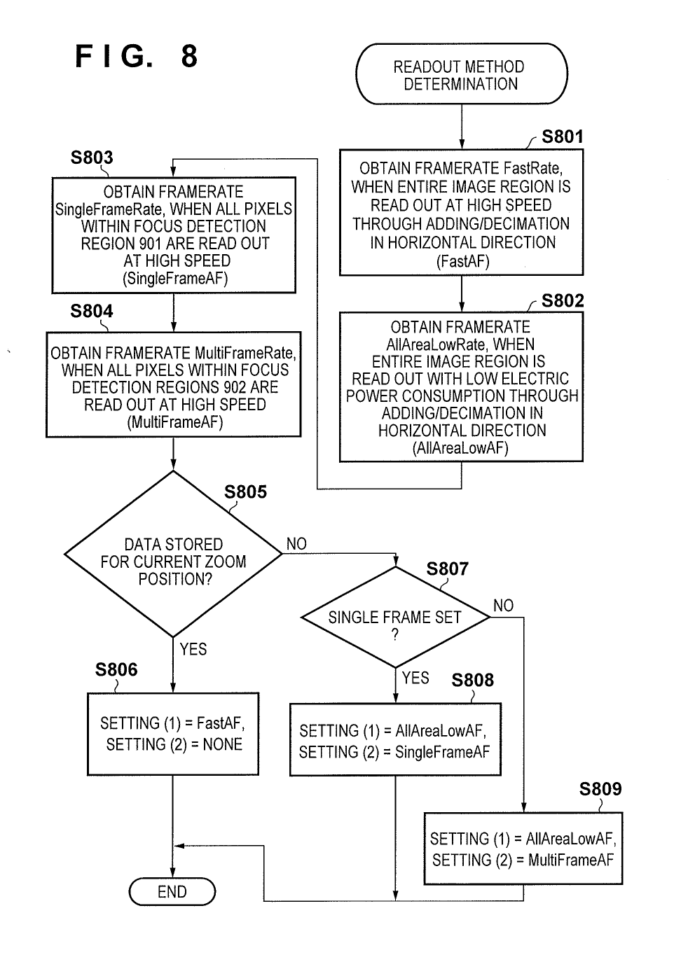

In step S602, a readout method is determined. Here, the procedure for determining the readout method carried out in step S602 will be described with reference to the flowchart in FIG. 8. First, in step S801, a framerate FastRate (a framerate of 180 fps, for example), when the entire image region, as shown in FIG. 9A, is read out at a high speed through adding and/or decimation in the horizontal direction, is obtained, and the process moves to step S802. Here, this readout setting is defined as “FastAF”.

Next, in step S802, a framerate AllAreaLowRate (a framerate of 30 fps, for example), when the entire image region is read out with low electric power consumption through adding and/or decimation in the horizontal direction, is obtained, and the process moves to step S803. Here, this readout setting is defined as “AllAreaLowAF”. It is assumed that the method for adding and/or decimation used here is the same method for adding and/or decimation used in readout under the aforementioned FastAF setting. Furthermore, reducing the framerate results in a lower electric power consumption than under the FastAF setting.

In step S803, a framerate SingleFrameRate (a framerate of 180 fps, for example), when all pixels within the focus detection region 901 shown in FIG. 9B are read out at a high speed, is obtained, after which the process moves to step S804. Here, this readout setting is defined as “SingleFrameAF”. Although this readout method takes time due to all of the pixels being read out, the framerate can be increased by limiting the readout to the focus detection region 901.

In step S804, a framerate MultiFrameRate (a framerate of 120 fps, for example), when all pixels within the focus detection regions 902 shown in FIG. 9C are read out at a high speed, is obtained, after which the process moves to step S805. Here, this readout setting is defined as “MultiFrameAF”. Although the framerate will be lower than the SingleFrameRate, the readout region is limited to the focus detection regions 902; as such, even if all of the pixels therein are read out, the framerate can still be kept higher than when reading out all of the pixels in the entire image region.

In step S805, it is determined whether or not differential data corresponding to the current zoom position is stored; the process moves to step S806 in the case where the differential data is stored, and moves to step S807 in the case where the differential data is not stored. Note that the differential data is data indicating a difference between focus evaluation value peaks caused by differences in the readout method, and is calculated and stored in step S615, which will be mentioned later. In step S806, the flow ends with a setting (1) set to FastAF and a setting (2) set to be unused, after which the process moves to step S603.

In step S807, it is determined whether or not the setting of the focus detection region is a single-frame setting, and in the case where the setting is a single-frame setting, the process moves to step S808, whereas in the case where the setting is not a single-frame setting, the process moves to step S809. In step S808, the flow ends with the setting (1) set to AllAreaLowAF and the setting (2) set to SingleFrameAF, after which the process moves to step S603. In step S809, the flow ends with the setting (1) set to AllAreaLowAF and the setting (2) set to MultiFrameAF, after which the process moves to step S603.

In step S603, a scanning range of the focus lens is set in accordance with the image capturing mode, the focal length, and so on, after which the process moves to step S604. In step S604, initial focus driving to move the focus lens to a starting position for AF scanning is carried out, after which the process moves to step S605. In step S605, the focus lens begins to be moved in a predetermined direction at a driving speed calculated based on the framerate of the readout method determined in step S602, after which the process moves to step S606. Here, the predetermined direction is set to the direction opposite from the driving direction of the focus lens during the initial focus driving carried out in step S604. Meanwhile, if two readout methods are set in step S602, the driving speed is calculated based on the framerate of the readout method of setting (2), whereas if one readout method is set, the driving speed is calculated based on the framerate of the readout method of setting (1).

In step S606, the image signal is read out using the single readout method determined in step S602, or, in the case of two readout methods, the image signals are read out in parallel using the two readout methods. In the case where the image signals are read out using the two readout methods, the image signal read out under setting (1) is used for a live display, and when capturing an image, the readout is carried out under exposure conditions suited to the live display, by taking the appearance of the EVF into consideration, for example. Meanwhile, the image signal read out under setting (2) is used in AF control, and when capturing an image, the readout is carried out under exposure conditions suited to AF control, taking into consideration the AF accuracy, the AF time, and so on. In step S607, a live image display is carried out using the image signal read out in step S606. Here, in the case where two readout methods have been set in step S602, the image signal read out under setting (1) is displayed, whereas in the case where only one readout method is set, the image signal read out under setting (1) is displayed.

In step S608, a focus evaluation value in the focus detection region set in step S601 is obtained for the image signal read out using the readout method determined in step S602, after which the process moves to step S609. Here, in the case where two readout methods have been set in step S602, focus evaluation values are calculated using the respective image signals read out using the two readout methods, whereas in the case where only one readout method is set, the focus evaluation value is calculated using the image signal read out using that readout method. When calculating the focus evaluation value, the respective image signals that are read out are processed with a band pass filter (BPF) to extract a high-frequency component; a computational process such as cumulative addition is furthermore carried out, and the focus evaluation value corresponding to a contour component amount (contrast) or the like in the high frequency range is calculated. The focus evaluation values are obtained in parallel at the framerates of the respective readout methods. In step S609, the current position of the focus lens 104 is obtained, and the process moves to step S610. In step S610, it is determined whether or not the obtained current position of the focus lens 104 is within the scanning range set in step S603; in the case where the current position is within the scanning range, the process returns to step S606, where the aforementioned processing is repeated. Through this, image capturing can be carried out a plurality of times, and a plurality of image signals can be obtained at different focus lens positions. On the other hand, in the case where the current position is not within the scanning range, the process moves to step S611.

Here, the series of operations from steps S606 to S610 are carried out in parallel in an amount of time equivalent to one frame's worth in the framerate, for the focus evaluation value calculated from the frames read out under setting (1) (called “focus evaluation value (1)” hereinafter) and the focus evaluation value calculated from the frames read out under setting (2) (called “focus evaluation value (2)” hereinafter).

Meanwhile, the focus evaluation value obtained in step S608 is associated with the lens position obtained in step S609, however, the focus lens 104 is moving while the focus evaluation value is being obtained, and thus the focus lens position at the center of the exposure time is calculated and associated with the focus evaluation value.

In step S611, the movement of the focus lens 104 is stopped, and the process moves to step S612. In step S612, a peak position where the focus evaluation value is maximum (an in-focus position) is calculated using the focus evaluation values obtained in step S608 and the corresponding positions of the focus lens 104 obtained in step S609. Here, the peak position is calculated for each of the focus evaluation value (1) and the focus evaluation value (2).

In step S613, it is determined whether or not there is differential data corresponding to the current zoom position; the process moves to step S614 in the case where there is differential data, and moves to step S615 in the case where there is no differential data. In step S614, the peak position is corrected using the differential data on the peak position of the focus evaluation value calculated in step S612, after which the process moves to step S616.

In step S615, a difference between the peak positions calculated from the focus evaluation values (1) and the focus evaluation values (2), respectively, is calculated, associated with the current zoom position, and stored. Although the difference is associated with the zoom position in the present embodiment, the difference may be associated with another image sensing condition, such as the focus lens position, luminance conditions, or the like.

A in-focus determination is carried out in step S616, after which the process moves to step S617, where the focus lens 104 is driven to the peak position of the focus evaluation value (2) found in step S612 or the peak position obtained by the correction carried out in step S614; the AF operations then end.

In this manner, AF control is carried out by simultaneously outputting the focus evaluation value generated using the signal from the entire image region and the focus evaluation value generated using only the signal from a partial image region, which makes it possible to quickly carry out AF while maintaining the AF accuracy.

Furthermore, a difference between the peak position of the focus evaluation values (1) generated using a signal resulting from adding and/or decimation in the entire image region and the peak position of the focus evaluation values (2) generated using a signal resulting from reading out all the pixels in the partial region is stored. Then, in the case where an image is to be captured under the same conditions, the peak position of the focus evaluation values calculated from the added and/or decimated image is corrected using the differential data. By doing so, it is unnecessary to carry out the two readouts in parallel, which achieves both fast AF and highly-accurate AF, and furthermore realizes low energy consumption.

Although two types of settings, namely setting (1) and setting (2), are used in the aforementioned embodiment, another readout method may be added as well, and three or more types of focus evaluation values may be read out in parallel and used.

Furthermore, the aforementioned embodiment describes a case where of a valid pixel region of the image sensor, image signals are read out from a partial focus detection region and the entire image region. However, the image signal may be read out from a region having a required size rather than from the entire image region. For example, in the case where digital zoom is employed, the image signal may be read out from a partial cut-out region.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-198897, filed on Sep. 25, 2013, which is hereby incorporated by reference herein in its entirety.

What is claimed is:

1. An image capturing apparatus comprising:
an image sensor;
a setting unit configured to set, in the image sensor, a first region for obtaining a focus detection signal, and a second region, for obtaining an image signal, that is larger than the first region and contains the first region;
a focus control unit configured to carry out focus control by finding an in-focus position of a focus lens using the focus detection signal output from the first region; and
a readout unit configured to read out the focus detection signal accumulated in the image sensor from the first region and reads out the image signal accumulated in the image sensor from the second region,
wherein the readout unit reads out the focus detection signal in parallel with the image signal, and sets a framerate of the focus detection signal read out from the first region to be higher than a framerate of the image signal read out from the second region.

2. The image capturing apparatus according to claim 1, wherein the focus control unit further finds an in-focus position based on the image signal obtained from the second region, obtains differential data indicating a difference between the obtained in-focus position and the in-focus position found based on the image signal obtained from the first region, and stores the differential data in a storage unit in association with an image sensing condition.

3. The image capturing apparatus according to claim 2, wherein the focus control unit determines whether or not differential data obtained under the same image sensing condition is stored in the storage unit, and in the case where differential data obtained under the same image sensing condition is stored, the focus control unit does not read out the image signal from the first region, and corrects, using the differential data obtained under the same image sensing condition, an in-focus position found based on the image signal obtained from the second region through decimating readout.

4. The image capturing apparatus according to claim 3, wherein in the case where the differential data obtained under the same image sensing condition is stored, the image sensor outputs the image signal from the first region faster than in the case where the differential data obtained under the same image sensing condition is not stored.

5. An image capturing apparatus comprising:
an image sensor;
a setting unit configured to set, in the image sensor, a first region for obtaining a focus detection signal, and a second region, for obtaining an image signal, that is larger than the first region and contains the first region;
a focus control unit configured to carry out focus control by finding an in-focus position of a focus lens using the focus detection signal output from the first region;
a readout unit configured to read out the focus detection signal accumulated in the image sensor from the first region and reads out the image signal accumulated in the image sensor from the second region; and
a display unit configured to display the image signal obtained from the second region,
wherein the readout unit obtains the image signal from the second region having carried out at least one of adding and decimation on the image signal; and
wherein the readout unit reads out the focus detection signal in parallel with the image signal, and sets a framerate of the focus detection signal read out from the first region to be higher than a framerate of the image signal read out from the second region.

6. The image capturing apparatus according to claim 5, wherein an addition rate of the focus detection signal read out from the first region is lower than an addition rate of the image signal read out from the second region, or a decimation rate of the focus detection signal read out from the first region is lower than a decimation rate of the image signal read out from the second region.

7. The image capturing apparatus according to claim 5, wherein the focus control unit further finds an in-focus position based on the image signal obtained from the second region, obtains differential data indicating a difference between the obtained in-focus position and the in-focus position found based on the image signal obtained from the first region, and stores the differential data in a storage unit in association with an image sensing condition.

8. The image capturing apparatus according to claim 7, wherein the focus control unit determines whether or not differential data obtained under the same image sensing condition is stored in the storage unit, and in the case where differential data obtained under the same image sensing condition is stored, the focus control unit does not read out the image signal from the first region, and corrects, using the differential data obtained under the same image sensing condition, an in-focus position found based on the image signal obtained from the second region through decimating readout.

9. The image capturing apparatus according to claim 8, wherein in the case where the differential data obtained under the same image sensing condition is stored, the image sensor outputs the image signal from the first region faster than in the case where the differential data obtained under the same image sensing condition is not stored.

10. A control method for an image capturing apparatus, the method comprising:
a setting step of setting, in an image sensor of the image capturing apparatus, a first region for obtaining a focus detection signal, and a second region, for obtaining an image signal, that is larger than the first region and contains the first region;
a readout step of reading out the focus detection signal accumulated in the image sensor from the first region and reading out the image signal accumulated in the image sensor from the second region; and
a focus control step of carrying out focus control by finding an in-focus position of a focus lens using the focus detection signal output from the first region,
wherein in the readout step, the focus detection signal is read out in parallel with the image signal, and a framerate of the focus detection signal read out from the first region is set to be higher than a framerate of the image signal read out from the second region.

11. A control method for an image capturing apparatus, the method comprising:
a setting step of setting, in an image sensor of the image capturing apparatus, a first region for obtaining a focus detection signal, and a second region, for obtaining an image signal, that is larger than the first region and contains the first region;
a readout step of reading out the focus detection signal accumulated in the image sensor from the first region and reading out the image signal accumulated in the image sensor from the second region;
a focus control step of carrying out focus control by finding an in-focus position of a focus lens using the focus detection signal output from the first region; and
a display step of displaying the image signal obtained from the second region,
wherein in the readout step, the image signal is obtained from the second region having carried out at least one of adding and decimation on the image signal; and
in the readout step, the focus detection signal is read out in parallel with the image signal, and a framerate of the focus detection signal read out from the first region is set to be higher than a framerate of the image signal read out from the second region.
